(19) United States
(12) Patent Application Publication
(10) Pub. No.: US 2024/0063405 A1
(43) Pub. Date: Feb. 22, 2024

(54) FUEL CELL ASSEMBLY HAVING TWO PARALLEL FUEL CELL SYSTEMS

(71) Applicant: CELLCENTRIC GMBH & CO. KG, Kirchheim/Teck-Nabern (DE)

(72) Inventors: Oliver HARR, Kirchheim/Teck-Nabern (DE); Philipp HAUSMANN, Kirchheim/Teck-Nabern (DE); Benjamin PIECK, Kirchheim/Teck-Nabern (DE)

(21) Appl. No.: 18/261,212

(22) PCT Filed: Jan. 20, 2022
(86) PCT No.: PCT/EP2022/051218

§ 371 Date: Jul. 12, 2023

(30) Foreign Application Priority Data
Jan. 22, 2021 (DE) 10 2021 000 329.2
Jan. 22, 2021 (DE) 20 2021 103 104.2

(51) Int. Cl. H01M 8/04111; H01M 8/04089; H01M 8/04119; H01M 8/249

(52) U.S. Cl. CPC H01M 8/04111; H01M 8/04097; H01M 8/04126; H01M 8/249

(57) ABSTRACT

The invention relates to a fuel cell facility (1) having two parallel fuel cell systems (13, 14), each of which comprises at least one fuel cell stack (15, 16, 17, 18) having anode-side and cathode-side periphery, and having a common air conveying device (2), The fuel cell facility (1) according to the invention is characterized in that the air conveying device (2) is designed in two stages, wherein both stages are designed in the form of flow compressors (3, 4) which each have one compressor wheel (8, 9, 10, 11) per stage, wherein the compressor wheels (8, 9; 10, 11) for the one and the other fuel cell system (13; 14) are arranged symmetrically to at least one electrical machine (5, 6) on a shaft (7).

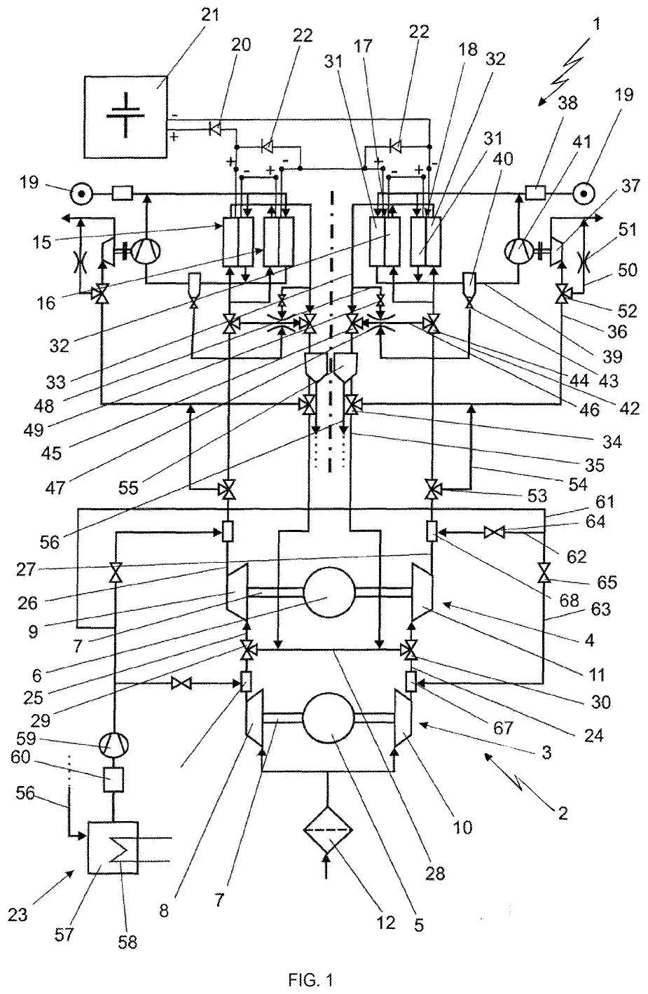

The invention relates to a fuel cell facility having two parallel fuel cell systems, each of which comprises at least one fuel cell stack having anode-side and cathode-side periphery. In addition, they comprise a common air conveying device.

Individual fuel cell systems are known in principle from the prior art. An exemplary fuel cell system can be found in DE 10 2009 043 569 A1. This system provides on the one hand a system bypass for connecting the pressure side to the exhaust air side and on the other hand a connection between the anode side and the cathode side via a blow-off line having a so-called blow-off or purge valve. In addition, a gas/gas humidifier typical in such fuel cell systems is indicated, which is used to humidify the supply air flow to the cathode compartment of the fuel cell by way of its moist exhaust air flow. In practice, however, these components are relatively large, complex, and expensive.

For the electrical power supply of larger systems, for example for the power supply of electric drive systems for commercial vehicles, such as buses or trucks, it can now be provided that two such fuel cell systems are used in parallel. They can then be combined to form a fuel cell facility, which can supply the power required for a truck in a comparatively simple manner by using two or more smaller fuel cell systems, for example two passenger vehicle fuel cell systems. This has been known and typical for a long time, particularly when used in buses.

It is problematic in such structures is that a large number of components are required twice. In particular, this relates to the relatively complex, large, and power-consuming components of the air supply and complex electrical components such as galvanically isolated DC/DC converters, which are required in such systems as step-up converters to provide the required voltage from the two individual fuel cell systems.

So-called electric turbochargers are often used for air supply in conventional fuel cell systems, which include a compressor wheel on one side and a turbine on the other side, symmetrically to an electric machine. This allows power to be recovered from the exhaust air of the fuel cell system via the turbine. However, it is critical that the load on the electric turbocharger is relatively high and that it has to be constructed in a correspondingly complex manner, in particular with regard to its axial bearings, since the force ratio between the turbine wheel on the one hand and the compressor wheel on the other hand causes high loads on the axial bearing. A further problem with the use of flow compressors, which is reasonable per se, is in their operating behavior, so that the desired ratio of volume flow to pressure often cannot be provided for the respective fuel cell system, or cannot be provided without blowing off already compressed air. This is also undesirable and in particular reduces the overall efficiency of the system, since already compressed air remains unused in order to be able to set the desired ratio of pressure and volume flow through the flow compressor.

The object of the present invention is now to specify an improved fuel cell facility having at least two parallel fuel cell systems, which is improved in particular with regard to the air supply.

According to the invention, this object is achieved by a fuel cell facility having the features in claim 1. Advantageous embodiments and refinements result from the claims dependent thereon.

The fuel cell facility having the two or more parallel fuel cell systems includes a common air conveying device. According to the invention, this air conveying device is designed as a two-stage air conveying device. Both stages are implemented in the form of flow compressors, which each have one compressor wheel per stage. The compressor wheels for one and the other fuel cell system are arranged symmetrically in relation to at least one electrical machine on a shaft. This enables a structure in which a very good compensation of axial forces is possible due to the symmetrical arrangement of the compressor wheels and the electric drive arranged between them. The efficiency may thus be increased, since the friction can be minimized. In addition, simpler and smaller axial bearings are possible, which is a further advantage.

According to an extraordinarily favorable refinement thereof, it is provided that each of the stages includes an electric drive machine and two compression wheels arranged symmetrically thereto for one and the other fuel cell system. In this particularly favorable embodiment, two flow compressors, each with two compressor wheels arranged symmetrically to the electric machine, are connected in series in the manner of register charging. According to a very favorable embodiment of the concept, the structure is operated in an isobaric manner in particular in order to achieve a good air supply for the two fuel cell systems in all or at least most of the required operating points efficiently and without having to blow off already compressed air. The compressor wheels on one side of the electric motors supply one fuel cell system as a two-stage system and the compressor wheels on the other side of the electric machines take over the air supply of the respective other fuel cell system.

In addition to the improved regular operation due to the two compressor stages per fuel cell system, which are operated in an isobaric manner in particular, the structure also enables a high degree of flexibility in a manner that will be described in more detail later, since, for example, exhaust gas recirculation lines, humidification, and the like are installed both in front of one and in front of the other stage and can therefore be placed between the two stages. When the first stage is switched off, the second stage can, for example, take on special tasks that will be described later, in order to maintain the basic functionality and service life of the two fuel cell systems of the fuel cell facility, for example by recirculating exhaust gas or the like.

According to a further extraordinarily favorable embodiment of the fuel cell facility according to the invention, the fuel cell stacks of the fuel cell systems are connected in series. This electrical combination of the fuel cell systems, wherein, according to a very favorable refinement of the fuel cell facility according to the invention, each of the fuel cell systems has two fuel cell stacks, which in turn are connected in series, makes it possible to dispense with expensive elements of the power electronics. For example, by connecting four fuel cell stacks in series in two fuel cell systems, a relatively high voltage can be achieved, due to which a simple common unit for distributing the power, a so-called power distribution unit PDU, is sufficient and no expensive galvanically isolated DC/DC converters are required in order to correspondingly step up the voltage of the two parallel fuel cell systems, as is typically the case in the prior art. The omission of the DC/DC converter saves installation space and costs. In addition, a connection of these power electronics to a cooling system can be omitted, which can also be a decisive advantage in terms of installation space and complexity. In addition, it is the case that, in principle, every DC/DC converter chops up the incoming voltage in order to be able to convert or adjust it accordingly. Although in practice this occurs at high frequency, such a chopped voltage always means a higher load for DC components than a continuously running continuous voltage, as can be achieved with the series connection mentioned.

The omission of complicated elements of the power electronics, which have to be provided twice in such a fuel cell system and are accordingly expensive and complex and require a large amount of space, is also possible with the mentioned electrical series connection of the fuel cell stacks because they can then be operated using a constant fuel cell current. The voltage can then be influenced solely via the stoichiometry according to the required operating points. For this purpose, the oxygen content can be increased accordingly by increasing the amount of air via the two-stage air supply of the air conveying device. If there is also the possibility of exhaust gas recirculation on the cathode side and, as is described in more detail below, according to an advantageous refinement, the possibility of actively extracting oxygen from the cathode side, there is a wide range of possible variations in the stoichiometry. This is completely sufficient for practical operation, so that the mentioned power electronics of the two fuel cell systems can be replaced by the mentioned very simple common PDU.

At least one of the fuel cell stacks, in particular the fuel cell stacks of one of the fuel cell systems, has a freewheeling diode in parallel to the fuel cell stack or stacks, so that operation is possible even in case of failure of one of the fuel cell systems, but then with reduced voltage, so that, for example, a truck equipped with such a fuel cell system can at least offer an emergency functionality, for example to drive to a workshop or to a hub in autonomous operation in order to check and/or service the fuel cell facility accordingly.

A very advantageous refinement of the fuel cell facility according to the invention can provide that the structure of each fuel cell system includes a so-called anode circuit, which is used for the recirculation of unused fuel, in particular hydrogen. This is recirculated around the anode compartment of the fuel cell stack or the two fuel cell stacks electrically connected in series in each of the fuel cell systems, i.e., fed back from the outlet of the anode compartment to the inlet. In the case of two fuel cell stacks per fuel cell system, these are fluidically connected in parallel for this purpose. In most operating situations, exhaust gas mixed with fresh hydrogen is fed back to the anode compartment in a manner known per se via the anode circuit. Each of the fuel cell systems additionally comprises a cathode bypass, i.e., for example, a line that is formed in parallel to the cathode.

In this very advantageous refinement of the fuel cell facility according to the invention, this cathode bypass branches off before or in the area of a valve device in the supply air line and opens into the exhaust air line after or in the area of a further valve device. All of this can be constructed around the cathode compartment of the fuel cell stack or stacks on the system side. However, it can also be entirely or partially integrated into this cathode compartment and/or its housing. The cathode compartment of one fuel cell stack or the cathode compartments of the two fuel cell stacks electrically connected in series, which are fluidically connected in parallel, are referred to simply as the “cathode compartment” hereinafter. This takes place similarly with the “anode compartment”.

With the described valve devices, the cathode compartment can be shut off and the air actually flowing towards and through the cathode compartment can be guided through the cathode bypass. Mixed forms of these two operating states are conceivable, possible, and often also useful. In this case, a gas jet pump driven by the air flowing around the cathode compartment is arranged in the cathode bypass. For the case that air is guided around the cathode compartment, the gas jet pump is therefore driven by this air as a propulsion jet. On the suction side, the gas jet pump is connected in a switchable manner both to the anode compartment and the cathode compartment. In this way, gases and possibly liquid can be extracted from the volume of the anode compartment or the anode circuit as well as from the volume of the cathode compartment. In the ideal case, the suction takes place relatively evenly in order to avoid excessive pressure differences between the cathode compartment and the anode compartment and thus to protect the membranes. The possibility of being able to extract gas from both the anode compartment and the cathode compartment, either alternatively or jointly, via the cathode bypass having the gas jet pump creates a large number of new application possibilities.

With regard to the structural design of the respective fuel cell system, according to a very advantageous embodiment of the concept, it can also be provided that in the anode circuit a fan is driven as a recirculation conveying device by an exhaust air turbine in the exhaust air line. Energy in the exhaust air can thus be used in the respective fuel cell system of the fuel cell facility. In contrast to many conventional fuel cell systems, this energy is not to be used in an electric turbocharger to assist the compression of the supply air, but to recirculate the anode exhaust gases in the anode circuit.

A particularly favorable embodiment of the fuel cell facility according to the invention also provides that in each of the fuel cell systems, at least one humidifier is arranged in the supply air before and/or after the second compressor stage, which is designed in particular in the form of a one-component or two-component nozzle. The humidifiers can therefore be designed simply in the form of a one-component or two-component nozzle. These humidifiers can be arranged in the supply air before and/or after the second compressor stage. As a result, the compression by the injected water, for example finely atomized water from a two-component nozzle, is correspondingly moist and atomized in the two-component nozzle by the air flowing around the actual water nozzle. This atomized water helps cool the air that heats up during compression and is vaporized in the air so that it is ideally humidified. Humidification can take place independently of the operation of the fuel cell, in particular with an electric drive of the corresponding humidifier, which is another very decisive advantage over a much more complex, larger, and more expensive gas/gas humidifier, which can be saved due to this construction.

Further advantageous embodiments of the fuel cell facility according to the invention also result from the exemplary embodiment, which is represented in more detail hereinafter with reference to the FIGURE.

The single attached FIGURE shows a schematic representation of a fuel cell facility according to the invention.

The fuel cell system 1 shown in the FIGURE comprises a common air conveying device 2, which is designed here in the form of two flow compressors 3, 4 connected in series in two stages. Each of the two flow compressors 3, 4 comprises an electric drive machine 5, 6 and, together with the respective electric drive machine 5, 6, each arranged on a common shaft 7, two symbolically illustrated compressor wheels 8, 9 on one, here the left side, and 10, 11 on the other, here the right side. In the exemplary embodiment illustrated here, the suction air reaches the compressor wheels 9, 11 of the first stage via a common air filter 12. The air filter 12 can, for example, be constructed as an activated carbon filter or, in particular comprise such a filter in order to protect the fuel cell facility not only from particles and dust but also from undesired chemical loads in the supply air.

The two flow compressors 3, 4 can be magnetically mounted, for example. They are in two stages and thus connected one after another in series on each of their sides and are operated in an isobaric manner. The right side of the structure having the compressor wheels 8, 9 supplies a first fuel cell system 13 with air. The other side having the compressor wheels 10, 11 supplies an identically constructed fuel cell system 14 on the other side of the FIGURE. Each of these two fuel cell systems 13, 14 comprises two fuel cell stacks 15, 16 and 17, 18, which are connected fluidically, i.e., with regard to the supply of air and oxygen, in parallel within each of the fuel cell systems 13, 14 and, for example, acquire hydrogen from a common hydrogen source, which is shared here but is shown twice and is designated by 19 in each case, and which can be designed in particular as a structure made up of a large number of compressed gas storage devices, cryogenic storage devices, metal hydride storage devices, or in principle also facilities for on-board hydrogen production.

Electrically, the respective fuel cell stacks 15, 16 of one fuel cell system 13 and the fuel cell stacks 17, 18 of the other fuel cell system 14 are all connected in series, as indicated here by the schematically indicated electrical connection to an exemplary battery system, designated by 21, for hybridizing the fuel cell facility 1. In case of a higher battery voltage, a current flowing to the fuel cell stacks 15, 16 and 17, 18, which would cause electrolysis there, is prevented via a blocking diode 20. At least one of the fuel cell systems 13, 14, but preferably both, each have a freewheeling diode, designated by 22, in parallel to the fuel cell stacks 15, 16 and 17, 18 connected in series. One of the fuel cell systems 13, 14 can thus be bypassed for emergency operation if it fails.

The structure of the fuel cell system 13, which, like the fuel cell system 14, is shown here purely by way of example and in simplified form, will be discussed in more detail hereinafter. The two fuel cell systems 13, 14 are designed identically to one another and are shown here mirrored, wherein both fuel cell systems 13, 14 use their own peripheral parts and components on the cathode and anode side, for example water separators, an anode circuit, a cathode circuit, an anode recirculation fan, and the like. They can have a common water supply system 23 here, which will be discussed in more detail in the following explanation.

In the air conveying device 2, the compressor wheels 8, 10 and 9, 11 of both stages are designed symmetrically and the respective electric machine 5, 6 as a drive lies in between on the same shaft 7 in each case. In this way, forces which are in the axial direction on the respective common shaft 7 are minimized. On the one hand, this helps to reduce friction power losses and, on the other hand, this allows axial bearings to be designed in a simple and efficient manner. Air is sucked in through the air filter 12 by the compressor wheels 8, 10 of the first flow compressor 3 via a common intake path or optionally also via two separate intake paths.

From the compressor wheel 8 and 10, the compressed air reaches the compressor wheel 9 and 11 of the second flow compressor 4 via a register line 24, 25 in each case. From there, the supply air, which is now more strongly compressed, reaches the fuel cell systems 13, 14 via supply air lines 26, 27. It is therefore a register charge. The two flow compressors 3, 4 work in an isobaric manner in particular. In addition, a bypass line 28 is provided, with a valve 29, 30 in each case on the respective register line 24, 25, which in principle makes it possible to blow compressed air between the stages.

The following explanations are now only based on the fuel cell system 14 shown to the right of the dash-dot dividing line, so that the components that are located identically in the other fuel cell system 13 are only provided with a reference number in this area.

The fuel cell system 14 comprises the two fuel cell stacks 17, 18, which are typically a stack of individual cells. They are connected electrically in series and fluidically in parallel. This applies to the fuel cell stacks 15, 16 of the other fuel cell system 13 analogously. Unlike the components described below, these still have their own reference signs due to the above explanation of the electrical interconnection. The two fuel cell stacks 17, 18 each comprise an anode compartment 31 and a cathode compartment 32. These are provided with the same reference signs in both fuel cell stacks 17, 18 and act more or less as if they were one anode compartment 31 and one cathode compartment 32 due to the fluidically parallel interconnection. Therefore, only one anode compartment 31 or cathode compartment 32 is always referred to hereinafter, even if both are meant.

The cathode compartment 32 is now supplied with air via the air supply line 27 via the air conveying device 2 having its two stages. Exhaust air reaches, via an exhaust air line 33, a valve device designated by 34, wherein this valve device 34 can also be designated as an exhaust air or exhaust gas recirculation valve 34. Optionally, the exhaust air from the exhaust air line 33 can be completely or partially returned via an exhaust air return line 35 to the bypass line 28 and from there to the register lines 24, 25 via this valve device 34, or to an exhaust air turbine 37, which will be explained in more detail hereinafter, via the part of the exhaust air line designated by 36.

The anode compartment 31 is supplied with hydrogen from the hydrogen storage device 19. This hydrogen reaches the anode compartment 31 via a pressure control and metering device 38. Exhaust gas returns from the outlet of the anode compartment 31 to its inlet via an anode circuit having a recirculation line designated by 39, in which a water separator 40 can be arranged, and flows into the anode compartment 31, mixed with fresh hydrogen in most operating states. In a manner known per se, a recirculation fan 41 can be arranged in the recirculation line 39 alternatively or additionally to a gas jet pump (not shown). A blow-off-line 42 having a so-called blow-off or purge valve 43 or purge/pressure relief valve is arranged in the water separator 40 or alternatively in another area of the recirculation line 39, via which valve, depending on the time, depending on the hydrogen concentration in the recirculation line 39, or also depending on other parameters, for example, gas from the recirculation line 39 is discharged, possibly together with water from the water separator 40.

In this construction of the fuel cell system 14, it is now possible to completely or partially return moist exhaust air via the exhaust air return line 35 with a corresponding position of the valve device 34, so that the humidification of the supply air in the supply air line 27 to the cathode compartment 32 of the fuel cell stacks 17, 18 is assisted. Alternatively or in particular additionally to the use of the liquid water system 23, which will be explained in more detail later, this can contribute to the fact that a conventional gas/gas humidifier can be dispensed with.

In contrast to conventional electric turbochargers, in which the pressure energy from the fuel cell system 14 is relieved and is additionally used to assist the drive of the air compressor, this pressure cannot be used for the air conveying device 2 here. Instead of an electric drive for the recirculation fan 41, as is typically provided, it is now provided that the exhaust air flows out of the cathode compartment 32 via an exhaust air turbine 37 which is arranged in the section 36 of the exhaust air line 33 and is coupled to the recirculation fan 41 in a power-transmitting manner, which is indicated here in the form of a common shaft. This makes it possible to drive the recirculation fan 41 via the energy contained in the exhaust air of the cathode compartment 32, in order to recover this energy and thus make the overall system more energy-efficient. It is particularly advantageous if the coupling between the exhaust air turbine 37 and the recirculation fan 41 takes place magnetically. As a result, the two volumes, which guide hydrogen or hydrogen-containing gas on the one hand and air on the other, can easily be hermetically sealed from one another. In the FIGURE, this is indicated by the two lines in the area of the shaft.

It is now advantageous for the structure of the fuel cell system 14 shown here that both in the supply air line 27 and in the exhaust air line 33, and here in each case relatively close to the cathode compartment 32, a valve device 44 is arranged in the direction of flow before the cathode compartment 32 and a valve device 45 is arranged in the direction of flow after the cathode compartment 32. These valve devices 44, 45 can preferably, and this is how it is shown here, be designed as 3/2-way valves. Essentially, however, they could also be implemented by independent valve devices, which are arranged both in the supply air line 27 and in the exhaust air line 33 and which would additionally be arranged in a cathode bypass 46. Essentially, the point is that the cathode bypass 46 is switchable via the valve devices 44, 45, specifically with the cathode compartment 32 closed off or the volume comprising the cathode compartment 32 closed off. Unlike a system bypass alone, the cathode bypass 46 is provided with a gas jet pump 47, which can be designed, for example, in the manner of a Venturi tube. However, any other type of gas jet pump or ejector or jet pump is also conceivable, as long as gases can be sucked in as a propellant gas flow from the air flowing around the cathode compartment 32 by negative pressure effects and/or momentum exchange. For this purpose, on the suction side, the gas jet pump 47 is connected to the blow-off line 42, which is switchable via the purge valve 43 in order to connect the recirculation line 39 to the gas jet pump 47. In this way, liquid and in particular gas can be extracted from the anode circuit and thus also out of the anode compartment 31. Since the anode circuit is otherwise formed sealed and forms a closed volume when the hydrogen supply is shut off, a negative pressure can be achieved in the anode circuit in this way, which is very favorable for the reasons that will be explained later.

The gas jet pump 47 is also connected on the suction side via a cathode branch line 48 and a cathode extraction valve 49 arranged therein to the cathode compartment 32 or to the volume lying between the valve devices 44, 45 and comprising the cathode compartment 32. The cathode branch line 48 can be arranged both before and after the cathode compartment 32, that is to say with an opening into the supply air line 27 or the exhaust air line 33. In principle, a direct connection to the fuel cell stack 17, 18 would also be conceivable, but this is technically much more complex than branching off from the corresponding line 27, 33. In this case as well, gas can now be extracted from the cathode compartment 32 by the gas jet pump 47 with the cathode extraction valve 49 open when flow occurs through the cathode bypass 46, which has the result that when the valve devices 44, 45 are closed, a negative pressure can also be generated in the cathode compartment 32. This will also be explained in more detail later with regard to the particularly advantageous use.

The recirculation fan 41, which is driven by the turbine 37 in the part of the exhaust air line 33 designated by 36, can also be bypassed via a turbine bypass 50 if necessary. This has a throttle point 51. The exhaust air turbine 37 can be bypassed by the exhaust air via a valve device 52, which is also designed here as a 3/2-way valve, so that the recirculation fan 41 is not driven. In the opposite case, in which the recirculation fan 41 is to be driven while the fuel cells 17, 18 of the fuel cell system 14 are not being supplied with air, a further valve device 53 is provided, which is connected via a line 54 to the section 36 of the exhaust air line 33 and thus enables air to be injected directly into the area of the exhaust air turbine 37. The line 54 thus forms a “classic” system bypass.

The liquid water system 23 already mentioned can preferably be filled with water, which is recovered from the fuel cell system 14. The fuel cell system 14 typically has the water separator 40 in the recirculation line 39 and a further water separator 55 in the area of the exhaust air line 33, and here if possible before the exhaust air turbine 37. In the exemplary embodiment of the fuel cell system 14 shown here, the water from the water separator 40 also reaches the water separator 55 via the gas jet pump 47 and the cathode bypass 46. Alternatively, a parallel line from the water separator 40, for example into the water separator 55 or directly into a water tank 57 of the liquid water system 23, would also be conceivable, in which all the water from all water separators 40, 55 of the fuel cell system 14 and also of the fuel cell system 13 collects. In the exemplary embodiment shown, starting from the water separator 55, a water line designated by 56 is shown for this purpose, which is taken up again in the drawing in the area of the liquid water system 23 and opens into the water tank designated by 57. As indicated via the heat exchanger 58 in the water tank 57, heat can be supplied to the water, for example via electrical heating. In particular, this can be formed by the freewheeling diodes 22 and their cooling as well as by the additional cooling of other power electronic components not shown here, such as a common PDU for the fuel cell stacks 15, 16, 17, 18 of the two fuel cell systems 13, 14.

The water stored in the water tank 57 ideally has a temperature of approximately 80° C., the water tank 57 therefore preferably has thermal insulation (not shown) in order to prevent the water tank 57 from cooling down quickly and unnecessarily. In the exemplary embodiment of the liquid water system 23 shown here, the insulated water tank 57 is followed by a water treatment unit, which is designated by 60 and which can include corresponding water filters and ion exchangers. The liquid water collected from the two fuel cell systems 13, 14 is then used to humidify the supply air flowing to the fuel cell stacks 15, 16, 17, 18. The explanation is again only on the side of the fuel cell system 14 and is to be understood analogously in the case of the fuel cell system 13. Two branch lines 62, 63 are supplied with water via the supply line 61, which can be designed, for example, as a pressurized water line in the manner of a common rail and is supplied with water from the water tank 57 via a water pump 59, these branch lines each conveying water in a switchable manner via the valves designated by 64, 65 to the humidifier 67 in the register line 24 and a humidifier 68 in the air supply line 27, thus after the second flow compressor 4.

Each of the humidifiers 67, 68 is preferably designed as a simple humidifier that atomizes the water using a one-component nozzle or a two-component nozzle. For example, it can be operated using electrical energy and thus independently of the operation of the fuel cell system 1 and controlled with regard to humidification. This means that, together with the exhaust gas recirculation, a complex conventional gas/gas humidifier can now be dispensed with during operation. This structure of the liquid water system 23 is also used in a similar way in internal combustion engine drives, in particular internal combustion engines having gasoline injection. The components such as the water pump 59, the heatable water tank 57, and the humidifier 67, 68 are therefore available on the market as sufficiently tried and tested parts in large numbers and accordingly inexpensively.

Such a fuel cell system 14, and of course also the fuel cell system 13 analogously, having the cathode bypass 46 and the gas jet pump 47 arranged therein, which is driven by the air flowing parallel to the cathode compartment 32 and which can extract both the cathode compartment 32 and the anode compartment 31 in a switchable manner, now enables numerous advantageous possibilities, via which some problems can be solved, which could not be solved or could not be solved comparably in previous fuel cell systems and which have disadvantageously influenced the safety and in particular the longevity of the individual cells in the fuel cell stacks 15, 16, 17, 18.

As already mentioned, such a fuel cell system 14 now allows special advantages in operational management. With an appropriately set exhaust gas recirculation valve 34, its compressor wheel 11 can be used during operation of the second flow compressor 4 in order to lament a recirculation of exhaust air around the cathode compartment 32. At the same time, part of this recirculated air can flow through the cathode bypass 46 and thus through the gas jet pump 47. This makes it possible, for example, to extract gases from the anode compartment 31 and/or the cathode compartment 32 if the purge valve 43 or the cathode extraction valve 49 is opened accordingly. Various applications are conceivable. For example, in case of an accident, when crash sensors of a utility vehicle (not shown here) that preferably includes the fuel cell facility 1 detect this accident, the hydrogen supply can be stopped. Using the remaining volume flow as the flow compressors 3, 4 run down, gas can then be extracted from the blocked cathode compartment 32 and the anode circuit and thus out of the anode compartment 31. As a result, the (open-circuit) voltage of the fuel cell stacks 15, 16, 17, 18 can be reduced very quickly when the load is shed and the current is reduced to zero, in order to prevent the occupants of the vehicle and rescue workers from being endangered. The same also applies to the reaction to the actuation of an emergency off switch or an emergency that is detected in the fuel cell facility 1 itself. This can also be applied analogously to stationary fuel cell facilities.

Furthermore, the oxygen content in the fuel cell stacks 15, 16, 17, 18 can be reduced in order to limit the cell voltage, for which purpose a corresponding amount of oxygen-depleted exhaust air is recirculated via the exhaust gas recirculation valve 34 and the exhaust gas recirculation line 35 and also assists the humidification of the supply air at the same time. If this is not sufficient, oxygen can also be actively extracted from the cathode compartment 32 when the cathode extraction valve 49 is open, by routing part of the supply air via the cathode bypass 46 and the gas jet pump 47, in order to limit the voltage in the individual cells in a more reliably controllable manner.

On the other hand, this possibility of influencing the stoichiometry of the individual fuel cell stacks 15, 16, 17, 18 more or less downwards can also be reversed by the two stages of the air conveying device 2. This is because in this way it is possible to make a relatively large amount of oxygen available and thus to influence the stoichiometry in the fuel cell stacks 15, 16, 17, 18 in the other direction. The possibility of being able to have a major influence on the stoichiometry in the fuel cell facility 1 by adapting and influencing the air supply, together with the parallel fluidic and electrical series connection of the fuel cell stacks 15, 16, 17, 18 of the two fuel cell systems 13, 14 already described above, enables complex power electronics to be dispensed with. Rather, the structure of the fuel cell facility, which consists of 980 individual cells of the four fuel cell stacks 15, 16, 17, 18 mentioned, for example, can be controlled with respect to the voltage solely via the stoichiometry. This therefore means that with a constant current from the fuel cell stacks 16, 16, 17, 18 of the fuel cell system 1, the provided and required voltage can be adjusted according to the required operating points solely via the stoichiometry. The oxygen content can be increased by the two flow compressors 3, 4 operated in an isobaric manner, and the oxygen content can be reduced in the supply of the cathode compartment 32 by the above-described measures of exhaust gas recirculation up to the active extraction of oxygen-containing gas from the cathode compartment 32.

Two very crucial points for the operation of the fuel cell system 14 relate to a preparation for a freeze start, a so-called FSU (Freeze Start Up) preparation. Because it is possible to lower the pressure in the anode compartment 31 and in the cathode compartment 32, for example down to 100 mbar, water present in both the anode compartment 31 and in the cathode compartment 32 can be evaporated and actively extracted via the gas jet pump 47. This can take place, for example, in a temperature window of 25 to 35° C. of the fuel cell stacks 17, 18. Unlike at higher temperatures, the membranes are largely prevented from drying out, so that the fuel cell stacks 17, 18 can be dried very gently. If the temperatures later fall below freezing point, the fuel cell stacks 17, 18 can be prevented from freezing beyond a desired or tolerable level. If the temperatures rise above the freezing point again, active humidification can be carried out even without the fuel cell stacks 17, 18 being actively started, since liquid water is available via the liquid water system 27 and, for example, can be easily and efficiently introduced into the supply air via the humidifier 68, which in particular can be designed as an electrically operated humidifier having a single-component nozzle. As already mentioned, this supply air can be circulated via the exhaust gas recirculation valve 34 in order to keep the membranes sufficiently moist on the one hand and on the other hand to be prepared for a freeze start at any time.

A strategy that has been typical until now for preparing for the start is to achieve as long a time as possible in which an air/hydrogen front is prevented in the anode compartment 31 when the fuel cell system is started. This always occurs when the hydrogen has diffused out of the anode compartment 31 and air has penetrated. If fresh hydrogen is then replenished, this dreaded front occurs, which damages the anode accordingly and has an extraordinarily disadvantageous and severe influence on the service life of the fuel cell stacks 17, 18. The fuel cell system 14 in the embodiment variant shown here now has several options for preventing such an air/air start.

The first possibility is that the cathode compartment 32 can be appropriately evacuated. If there is no oxygen therein, the front cannot develop its damaging effect even if oxygen is present on the anode side and is displaced by hydrogen flowing in during the start. This simple possibility can provide, for example, for the cathode to be permanently kept free of oxygen, which, given the leak-tightness that typically occurs in the system, requires the cathode compartment 32 to be evacuated again, for example, every ten hours or the like. Since such a recurring evacuation is relatively risky for the membranes, as they can dry out, this procedure can be accompanied in particular by the humidification of the membranes described above when the temperatures are above the freezing point and a safe and reliable start is possible even with a certain residual moisture in the fuel cell facility 1.

A second possibility for avoiding an air/air start is to extract the air, which has also penetrated into the anode compartment 31 while the fuel cell system 14 was at a standstill, out of the anode compartment 31 again, i.e., evacuating it, before the start. For this purpose, air is conveyed and flows via the cathode bypass 46 and the gas jet pump 47. When the purge valve 43 is open, the air which has penetrated into the anode compartment 31 during the standstill can be extracted. This makes it possible to at least significantly reduce the oxygen content in the volume of the anode compartment 31 and ultimately also in the anode circuit before the hydrogen is metered in at the start. This also allows a gentle start to be implemented and the service life of the fuel cell stacks 17, 18 to be extended.

The third option uses the generation of nitrogen or oxygen-depleted air, in particular air having an oxygen content of 0%, in order to implement a very gentle start. The circulation guidance around the cathode compartment 32 is used for this purpose. Hydrogen metered into the anode circuit or residual hydrogen still present therein is sucked in via the gas jet pump 47 when the purge valve 43 is open and thus enters a circuit, which is maintained by the operation of the second flow compressor 4, together with the oxygen-containing air. The air then flows in a circuit around the cathode compartment 32. It flows partially through the cathode compartment 32 and partially through the cathode bypass 46. It then flows via the exhaust air line 33 and the exhaust gas recirculation valve 34 and the exhaust gas recirculation line 35 back into the register line 24 and from there, driven by the compressor wheel 11, back to the valve device 44 in the supply air line 27. The mixing of hydrogen and air in this operation now results in a reaction of the hydrogen and the oxygen, for example on the catalysts of the anode compartment 31 or in the area of a catalyst (not shown) specially provided for this purpose, which can be arranged, for example, in the cathode bypass 46 after the gas jet pump 47. In the case of the additional catalyst, the cathode compartment 32 does not have to have continuous flow through it in order to generate the nitrogen. This reduces the drying out of the membranes and protects them. If necessary, however, they could also be remoistened, as explained above.

The fourth option for avoiding an air/air start is to some extent a combination of the second and third options. In addition, a hydrogen metering line is required for this, via which hydrogen can be metered onto the cathode side. This hydrogen metering line is connected to the gas jet pump 47 in the cathode bypass 46 in a manner similar to or as an alternative to the purge line 42. It is thus possible to meter hydrogen via the hydrogen metering line onto the cathode side of the fuel cell system 14 without this hydrogen having to flow through the anode compartment 31 beforehand. Oxygen in the air can thus be consumed by the catalyst already mentioned above, which is connected downstream of the gas jet pump 47 in the circuit around the cathode compartment 32. This air is then recirculated autonomously in this circuit with the aid of the valve devices 44, 45 and the exhaust gas recirculation valve 34 and by the operation of the compressor wheel 11. This continues until the oxygen content in the original air is reduced to less than 1 percent by volume, in particular to approximately 0 percent by volume, with the aid of the catalyst and the hydrogen entering the circuit via the hydrogen metering line in the area of the mixing point in the gas jet pump 47. The gas then recirculated is thus quasi-free of oxygen and essentially consists of nitrogen.

This gas is heated at the same time by the recirculation via the compressor wheel 11, which promotes the catalytic reaction in the catalyst in order to react oxygen and hydrogen efficiently. A temperature range of approximately +60 to +80° C. is ideal for this. This allows the catalytic reaction to be controlled very well in order to avoid unwanted nitrogen oxides within the closed volume. These nitrogen oxides as a by-product are undesirable due to the emissions of the same occurring later, but would not further impair the handling of the fuel cell stacks 17, 18, which protects the service life.

After some time, all the oxygen will be concerned if sufficient hydrogen is available or has been replenished accordingly. In the entire circuit there is now gas which has been depleted to 0% oxygen. This is essentially nitrogen, excluding carbon dioxide and some noble gases, which do not disadvantageously affect the method. Now that nitrogen is present in the circuit, the purge valve 43 can be opened and the second flow compressor 4 can be switched off. The cathode extraction valve 48 and/or the valve devices 44, 45 are opened. The nitrogen then flows back into the fuel cell stack 17, 18 via the purge line 42 and the cathode branch line 48 and/or the air supply line 27, so that these are filled with nitrogen. This enables an extraordinarily gentle start during the next start process, without the damaging mechanisms of the air/air start occurring.

A fifth option can also be ideally used in the construction of the fuel cell system 14 in combination with the previously typical way of keeping the hydrogen in the system. Ideally, using a slight static overpressure in comparison to the air pressure in the surrounding atmosphere, the volumes of both the anode compartment 31 and the cathode compartment 32 are filled with hydrogen and kept under a slight overpressure in order to ensure that the volume is completely inerted by a hydrogen concentration of almost 100 percent. Before the regular start, the residual hydrogen present in the cathode compartment 32 can now be removed again via the gas jet pump 47 and its operation by the supply air that has already been conveyed but is not flowing into the cathode compartment 32, in that the hydrogen is completely extracted from the cathode compartment 32 before oxygen or oxygen-containing air is then applied to the cathode compartment 32 by opening the valve device 44 in the direction of the cathode compartment 32, in order to be able to start the fuel cell system 14 or its fuel cell stack 17, 18.

In order to still get oxygen into the anode compartment 31 from time to time in order to oxidize accumulated CO contamination there, the fuel cell stacks 17, 18 can be evacuated again using the gas jet pump 47 in the cathode bypass 46. When the purge valve 43 is open, air or oxygen-containing gas can reach the area of the anode compartment 31 with the air compressor switched off. In principle, the passive oxidation of carbon monoxide to carbon dioxide is conceivable. It becomes more efficient if the recirculation conveying device 31 is operated, for example by operating the air conveying device 2 or one of its stages again after the air has flowed over into the anode circuit with the purge valve 43 initially closed, in order to, in the exemplary embodiment shown here, to drive the recirculation conveying device 41 in the form of the fan via the exhaust air turbine 37. The refresh of the catalyst is then completed after a short time, for example in the order of magnitude of less than a minute. The oxygen-containing gas can then be extracted from the anode circuit again by opening the purge valve 43 again, and the system can be filled with nitrogen, for example, in the manner described above, in order to prepare it for the next start.

All of this applies analogously to the other fuel cell system 13 with its fuel cell stacks 15, 16 and is preferably always carried out in both fuel cell systems 13, 14 at the same time.

What is claimed is:

1. A fuel cell facility having two parallel fuel cell systems, each of which comprises at least one fuel cell stack having anode-side and cathode-side periphery, and having a common air conveying device,
wherein
the air conveying device is designed in two stages, wherein both stages are designed in the form of flow compressors which each have compressor wheels per stage, wherein the compressor wheels for the one and the other fuel cell system are arranged symmetrically to at least one electrical machine on a shaft.

2. The fuel cell facility as claimed in claim 1,
wherein
each of the stages includes an electric machine and two of the compressor wheels which are arranged symmetrically to the electric machine, one for one and the other for the other of the fuel cell systems, respectively.

3. The fuel cell facility as claimed in claim 1,
wherein
the two stages of the air conveying device are designed for isobaric operation.

4. The fuel cell facility as claimed in claim 1,
wherein
the fuel cell stacks of the fuel cell systems are electrically connected in series.

5. The fuel cell facility as claimed in claim 1,
wherein
each of the fuel cell systems includes two fuel cell stacks which are electrically connected in series.

6. The fuel cell facility as claimed in claim 1,
wherein
the fuel cell systems comprise a common electrical power distribution unit.

7. The fuel cell facility as claimed in claim 1,
wherein
the at least one fuel cell stack of at least one of the fuel cell systems is arranged in parallel to a freewheeling diode.

8. The fuel cell facility as claimed in claim 1,
wherein
an exhaust air line from a cathode compartment of the fuel cell stack or stacks of each fuel cell system and at least one fuel supply device for supplying the anode compartments with fuel are provided, wherein at least one anode circuit for recirculating unused fuel around the anode compartment or the anode compartments of each fuel cell system and at least one cathode bypass for bypassing the cathode compartment or the cathode compartments of each fuel cell system are provided, wherein the cathode bypass of each fuel cell system branches off before or in the area of a valve device in a supply air line and opens into a further valve device in an exhaust air line downstream of or in the area of the latter, wherein a gas jet pump drivable by the air flowing around the cathode compartment is arranged in the cathode bypass and is connected in a switchable manner on the suction side to the anode compartment and/or the cathode compartment.

9. The fuel cell facility as claimed in claim 8,
wherein
in the respective anode circuit, in each case a fan is driven as a recirculation conveying device by an exhaust air turbine in the exhaust air line of the respective fuel cell system.

10. The fuel cell facility as claimed in claim 2,
wherein
in each of the fuel cell systems at least one humidifier is arranged in the supply air before and/or after the second compressor stage, which is designed in particular in the form of a one-component or two-component nozzle.

11. The fuel cell facility as claimed in claim 2,
wherein
the two stages of the air conveying device are designed for isobaric operation.

12. The fuel cell facility as claimed in claim 2,
wherein
the fuel cell stacks of the fuel cell systems are electrically connected in series.

13. The fuel cell facility as claimed in claim 3,
wherein
the fuel cell stacks of the fuel cell systems are electrically connected in series.

14. The fuel cell facility as claimed in claim 2,
wherein
each of the fuel cell systems includes two fuel cell stacks which are electrically connected in series.

15. The fuel cell facility as claimed in claim 3,
wherein
each of the fuel cell systems includes two fuel cell stacks which are electrically connected in series.

16. The fuel cell facility as claimed in claim 4,
wherein
each of the fuel cell systems includes two fuel cell stacks which are electrically connected in series.

17. The fuel cell facility as claimed in claim 2,
wherein
the fuel cell systems comprise a common electrical power distribution unit.

18. The fuel cell facility as claimed in claim 3,
wherein
the fuel cell systems comprise a common electrical power distribution unit.

19. The fuel cell facility as claimed in claim 4,
wherein
the fuel cell systems comprise a common electrical power distribution unit.

20. The fuel cell facility as claimed in claim 5,
wherein
the fuel cell systems comprise a common electrical power distribution unit.
